(19) United States
(12) Patent Application Publication
(10) Pub. No.: US 2016/0368424 A1
(43) Pub. Date: Dec. 22, 2016

(54) RETRACTABLE CARGO NET FOR VEHICLE

(71) Applicant: FORD GLOBAL TECHNOLOGIES, LLC, Dearborn, MI (US)

(72) Inventors: Iskander Farooq, Novi, Oakland, MI (US); Mohammed Omar Faruque, Ann Arbor, MI (US); Dean M Jaradi, Macomb, MI (US)

(21) Appl. No.: 14/743,150

(22) Filed: Jun. 18, 2015

(51) Int. Cl. B60R 5/04; B60R 11/00

(52) U.S. Cl. CPC B60R 5/04; B60R 11/00; B60R 2011/0036

(57) ABSTRACT

A vehicle having a cargo area partially defined by a floor and a lift gate includes a support rod anchored for rotational movement substantially within a recess beneath the floor and adjacent the lift gate. A flexible member, such as a cargo net, is attached to the support at a first end and rolled around the support in a stowed position. The flexible member is unrolled from the support in an extended position. A cover is attached to the flexible member at a second end and the cover is substantially flush with the floor concealing the support and the flexible member in the stowed position. The vehicle may incorporate multiple support rods, flexible members, and covers.

### TECHNICAL FIELD

This document relates generally to cargo nets for vehicle cargo areas, and more specifically to a retractable cargo net.

### BACKGROUND

It is well known that vehicle cargo areas, especially those that are flush with a rear lift gate or deck lid of a vehicle, have a problem with retaining cargo (e.g., groceries, boxes, and/or packets/suitcases) inside the compartment when the lift gate or deck lid is opened. Acceleration of the vehicle can overturn cargo and/or shift cargo to a rear extreme of the cargo compartment where the cargo falls out of the cargo area as soon as the lift gate or deck lid is opened. This problem is exacerbated when the vehicle is parked on an inclined driveway or roadway. Fragile cargo, such as eggs or glass jars, can break upon falling and contacting the ground and cargo can be lost or damaged as a result. Vehicle owners are expectedly frustrated and upset when such events occur.

After-market cargo nets or grocery retaining meshes, and bins are available to combat these types of problems. The after-market cargo nets, however, have their own drawbacks. For instance, after-market cargo nets require a time consuming manual installation process to be performed by the vehicle owner. A typical installation requires positioning four loops extending from the corners of the cargo net over buttons or hooks positioned within the cargo area. Once installed, the cargo net remains a barrier to loading cargo into the cargo area until removed or partially removed. This barrier defeats one positive aspect of a flush cargo area, i.e., ease of placement of goods into the rear cargo area.

In order to retain this positive aspect, the after-market cargo net must be installed, removed after delivery of the cargo, stowed, and reinstalled after the placement of additional cargo in the rear cargo area. This installation, removal, stowing, and reinstallation process often becomes burdensome and/or an inconvenience for the vehicle owner rather than a useful tool. Even more, the after-market cargo nets are often misplaced or lost, stowed loose in the rear cargo area where they can be in the way of unfettered use of the rear cargo area, or damaged when stowed loose and other cargo is loaded into the rear cargo area.

Accordingly, a need exists for a cargo net for a vehicle cargo area that is quickly and easily moved from an out of sight, stowed position to an installed position to prevent cargo from shifting within the rear cargo area during driving and/or falling out of the rear cargo area as soon as the lift gate or deck lid is opened. Such a cargo net would further be quickly and easily uninstalled and returned to the stowed position. Preferably, the stowed position would hold the cargo net in a readily accessible location near the vehicle lift gate or deck lid and would not create an obstruction to loading cargo and/or simply be in the way when not in use. Even more, the cargo net would be stowed out of sight in a manner that does not detract from the aesthetic appearance of the cargo area.

### SUMMARY OF THE INVENTION

In accordance with the purposes and benefits described herein, a vehicle having a cargo area is partially defined by a floor and a lift gate. The vehicle may be broadly described as including a support bar anchored for rotational movement adjacent the lift gate, a flexible material attached to the support bar at a first end, the flexible material rolled around the support bar in a stowed position and unrolled from the support bar in an extended position, and a cover attached to the flexible material at a second end and concealing the support bar and the flexible material in the stowed position and maintaining the flexible material in the extended position.

In accordance with one possible embodiment, the vehicle may further include at least one spring associated with the support bar with the at least one spring being in an unenergized state in the stowed position and an energized state in the extended position. In another possible embodiment, the at least one spring is a coil type spring. In yet another embodiment, the support bar includes at least one outboard compartment for housing the at least one spring.

In accordance with yet another possible embodiment, the support bar and the flexible material are positioned within a recess formed in the floor in the stowed position.

In accordance with one other possible embodiment, the vehicle may further include first and second pins extending from ends of the support bar, first and second grommets attached to a wall of the recess for receiving the first and second pins, and first and second brackets attached to the first and second grommets and securing the first and second pins within the first and second grommets for rotational movement of the support bar.

In another possible embodiment, the cover is substantially flush with the floor in the stowed position. In another, the cover includes a tab for grasping when moving the flexible material from the stowed position to the extended position. In still another, the cover includes an aperture for inserting a tool therein when moving the flexible material from the stowed position to the extended position.

In one additional possible embodiment, a vehicle having a cargo area partially defined by a floor and a lift gate includes a support anchored for rotational movement substantially within a recess beneath the floor and adjacent the lift gate, a retractable flexible member attached to the support at a first end, the retractable flexible member rolled around the support in a stowed position and unrolled from the support in an extended position, and a cover attached to the retractable flexible member at a second end, wherein the cover is substantially flush with the floor and conceals the support and the retractable flexible member in the stowed position.

In another possible embodiment, the vehicle further includes first and second springs attached to the support bar such that the first and second springs are in an unenergized state in the stowed position and an energized state in the extended position. In yet another, the support includes first and second outboard areas for receiving the first and second springs.

In still another possible embodiment, the cover is anchored, in the extended position, to an interior structure of the vehicle. In another, the vehicle further includes a carpet covering the floor, and a color of the cover substantially matches a color of the carpet.

In one other possible embodiment, the vehicle further includes at least one additional support anchored for rotational movement substantially within a recess beneath the floor within the cargo area, at least one additional retractable flexible member attached to the at least one additional support at a first end, the at least one additional retractable flexible member rolled around the at least one additional support in a stowed position and unrolled from the support in an extended position, and at least one additional cover attached to the at least one additional retractable flexible member at a second end, wherein the at least one additional cover is substantially flush with the floor and conceals the at least one additional support and the at least one additional retractable flexible member in the stowed position.

In still another possible embodiment, a vehicle having a cargo area partially defined by a floor and a lift gate includes a retractable net anchored at a first end within a recess in the floor, the retractable net rolled around a support and positioned within the recess in a stowed position and secured at a second end to an interior structure of the vehicle in an extended position, and a cover, the cover substantially flush with the floor and concealing the retractable net in the stowed position.

In another possible embodiment, the support is anchored for rotational movement within the recess and the retractable net is attached to the support at the first end. In yet another, the vehicle further includes a pair of springs positioned along opposing ends of the support and acting upon the support, the pair of springs being in an unenergized state in the stowed position and an energized state in the extended position.

In a different possible embodiment, the retractable net is attached to a handle at a second end and, in the extended position, the handle is secured to an interior structure of the vehicle. In another possible embodiment, the retractable net is attached to the cover at a second end and, in the extended position, the cover is secured to an interior structure of the vehicle.

In the following description, there are shown and described several embodiments of a retractable cargo net for a vehicle cargo area and a vehicle incorporating same. As it should be realized, the invention is capable of other, different embodiments and its several details are capable of modification in various, obvious aspects all without departing from the assemblies as set forth and described in the following claims. For example, a plurality of retractable cargo nets may be utilized within the vehicle cargo area to subdivide the cargo area as desired. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the retractable cargo net for a vehicle cargo area and together with the description serve to explain certain principles thereof. In the drawing figures:

FIG. 1 is a partial perspective view of a typical vehicle having a rear cargo area showing a cover for a retractable cargo net positioned flush with a floor of the rear cargo area;

FIG. 2 is a partial perspective view of a cargo net rolled around a support bar in a stowed position;

FIG. 3 is a partial perspective view of the cargo net being unrolled from the support bar in the stowed position to an extended position within the rear cargo area;

FIG. 4 is a partial perspective view of the cargo net secured in the extended position within the rear cargo area;

FIG. 5 is a side plan view of a cover for the cargo net showing a slot for receiving a finger or other tool for raising the cargo net from the stowed position;

FIG. 6 is a side plan view of an alternate cover for the cargo net showing a tab for contact by a finger or other tool for raising the cargo net from the stowed position;

FIG. 7 is a partial perspective view of a typical vehicle having a rear cargo area showing a pair of covers for retractable cargo nets positioned flush with a floor of the rear cargo area; and

FIG. 8 is a partial perspective view of the pair of cargo nets secured in extended positions within the rear cargo area.

Reference will now be made in detail to the present preferred embodiments of the retractable cargo net for a vehicle cargo area for a vehicle, examples of which are illustrated in the accompanying drawing figures, wherein like numerals are used to represent like elements.

### DETAILED DESCRIPTION

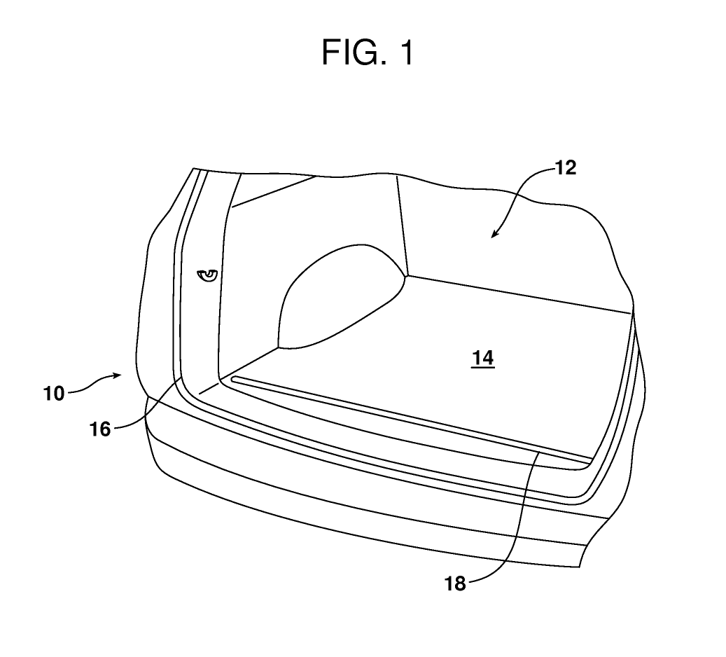

Reference is now made to FIG. 1 which illustrates a typical vehicle 10 having a rear cargo area 12 including a floor 14 that is substantially flush with a rear lift gate opening frame 16 for a rear lift gate (not shown). The floor 14 can be covered with carpet or the like as is known in the art. A cover 18 obscures a cargo net 20 from view in a stowed position essentially adjacent the rear lift gate. The cover 18 is substantially flush with the carpet of the floor 14 and extends at least across the width of the rear lift gate opening frame 16. The cover 18 may be color matched to the carpet and/or the floor 14.

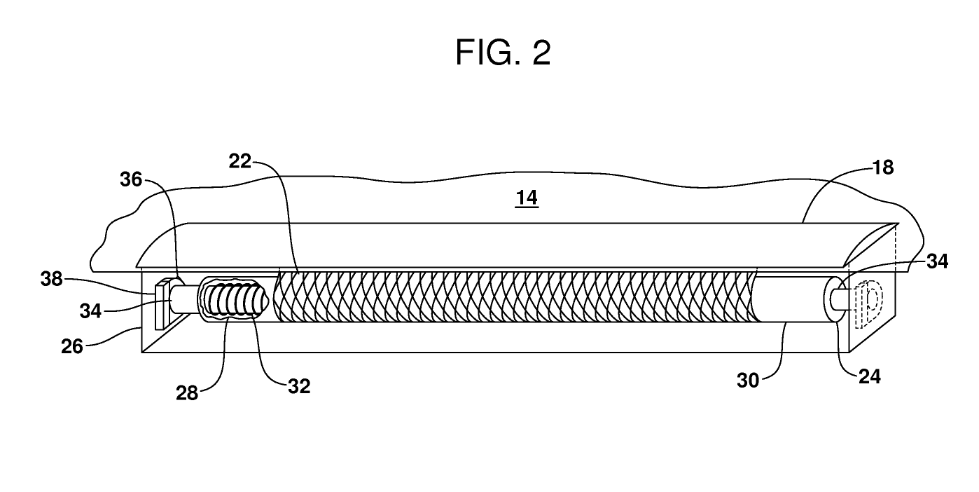

As shown in FIG. 2, the cargo net 20 is attached at a first, lengthwise end 22 to a support bar 24 and rolled around the support bar in the stowed position. The support bar 24 is a rod in the described embodiment but could be a bar, a tube, or even a square bar so long as the bar can support the cargo net and rotate allowing the cargo net to unroll and extend from the stowed position.

As with the cover 18, the cargo net 20 extends across a width of the vehicle sufficient to cover the width of the rear lift gate opening frame 16. The cargo net 20 is made of a plastic fabric in the described embodiment but could also be made of a cloth type fabric, nylon, or a similar material suitable for retaining cargo. In the stowed position, the cargo net 20 and support bar 24 are secured for rotational movement in a recess 26 formed in the floor 14 of the cargo area 12 in the described embodiment.

As further shown in FIG. 2, the support bar 24 has outboard compartments 28, 30 where a spring 32 can be installed. The springs are a coil type in the described embodiment but could also be compression springs, torsion springs, clock springs, or other types of springs or combinations thereof. The springs 32 are energized by extension of the cargo net 20 and store potential energy until the cargo net is released at which time the energy stowed in the springs acts to return the cargo net to the stowed position. In alternate embodiments, one or more springs may be utilized and positioned in differing locations so long as they are sufficient to return the cargo net to the stowed position.

The support bar 24 further includes integral pins 34 extending from opposing ends for pivotally anchoring the support bar within the recess 26 in the rear cargo area 12 in the stowed position. Grommets 36 are attached to sides of the recess 26 for receiving the integral pins 34 of the support bar 24 which is secured in position by brackets 38 attached to the grommets or to the sides of the recess adjacent the grommets. In this manner, the pins 34 extending from the support bar 24 are essentially captured between the grommets 36 and the brackets 38 within the recess 26 while allowing rotation of the support bar 24.

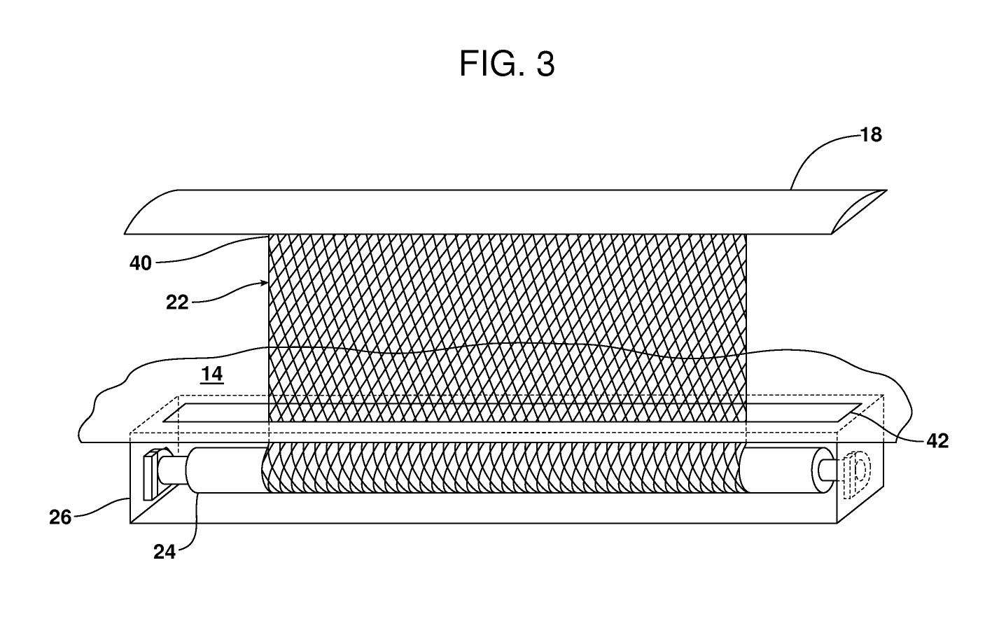

As shown in FIG. 3, the cargo net 22 is attached at a second, lengthwise end 40 to the cover 18. The cover 18 is long and wide enough to cover an opening 42 through which the cargo net 22 moves during extension and retraction between positions. The force of the springs 32 on the cargo net 22 holds the cover 18 tight against the floor/carpet 14 when the cargo net is in the stowed position. In operation, the cover 18 is acted upon by an operator and pulled from the stowed position thereby unrolling the cargo net 22 and extending the cargo net upward toward the extended position.

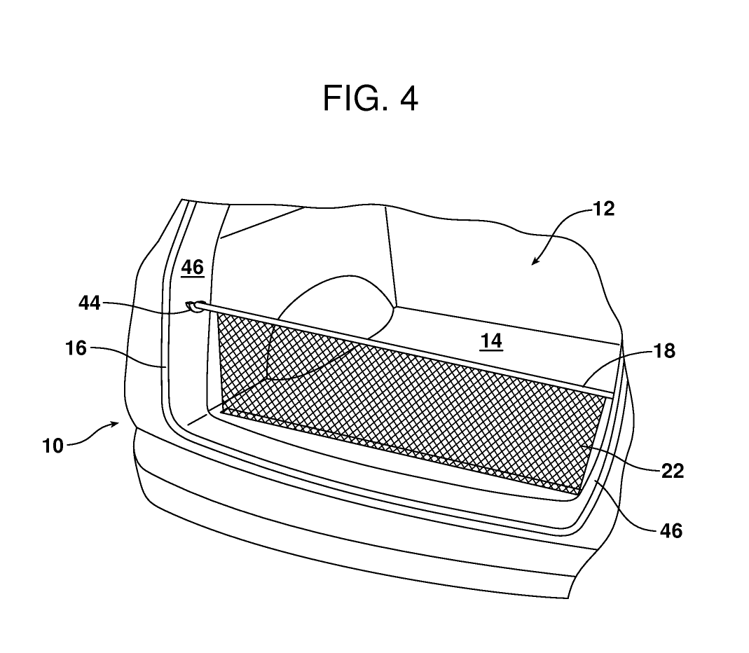

Once the extended position is reached, the cover 18 is secured or attached by receivers 44 or the like positioned on sides 46 of the lift gate opening frame 16 as shown in FIG. 4. In this extended position (or installed position), the cargo net 22 is fully functional to prevent cargo from falling out of the cargo area 12 as soon as the lift gate or deck lid is opened. Even more, the torsion springs are energized to facilitate quick and easy uninstallation and return to the stowed position.

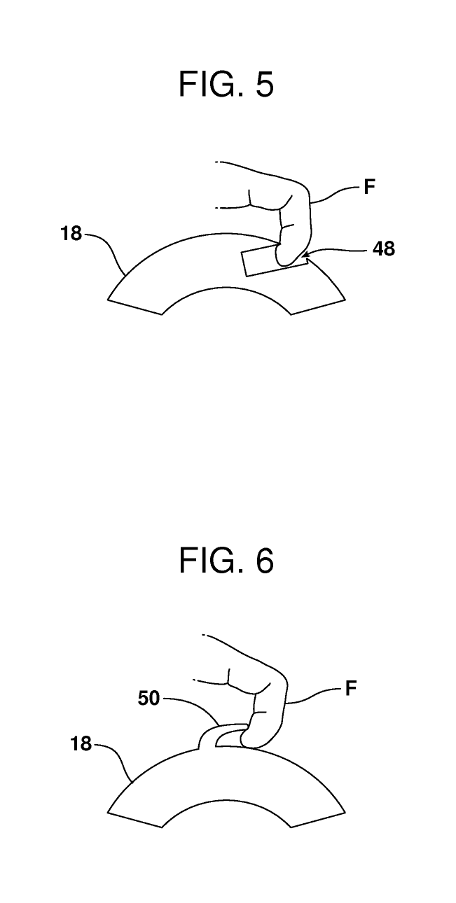

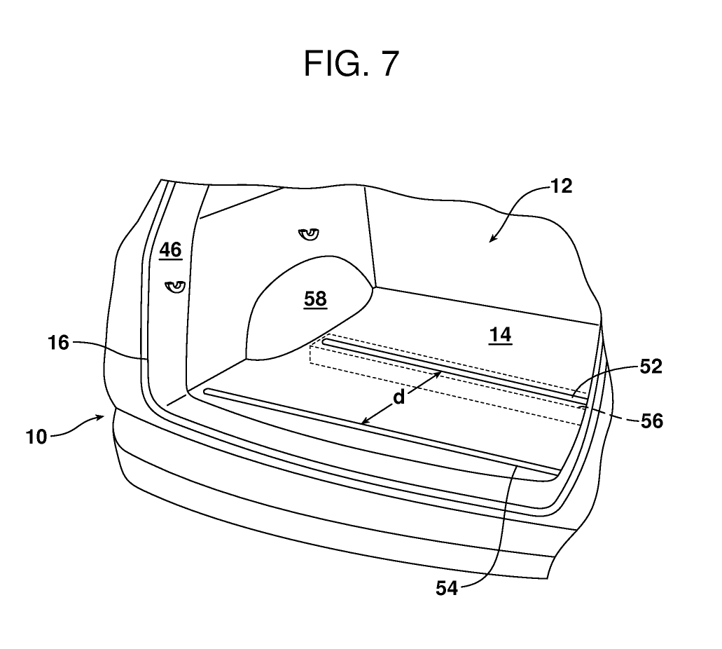

As shown in FIG. 5, the cover 18 includes a recess 48 therein for receiving a finger (F) of the operator, or other tool, to assist in initiating movement of the cover from the stowed position which is essentially flush with the cargo area floor 14. One possible alternate embodiment, shown in FIG. 6, includes a tab 50 for holding or grasping by the operator (F) to assist in initiating movement of the cover 18. Of course, additional other alternate embodiments could be utilized to provide assistance in initiating movement of the cover such as a knob attached to the cover at one or both ends, or a string or strap.

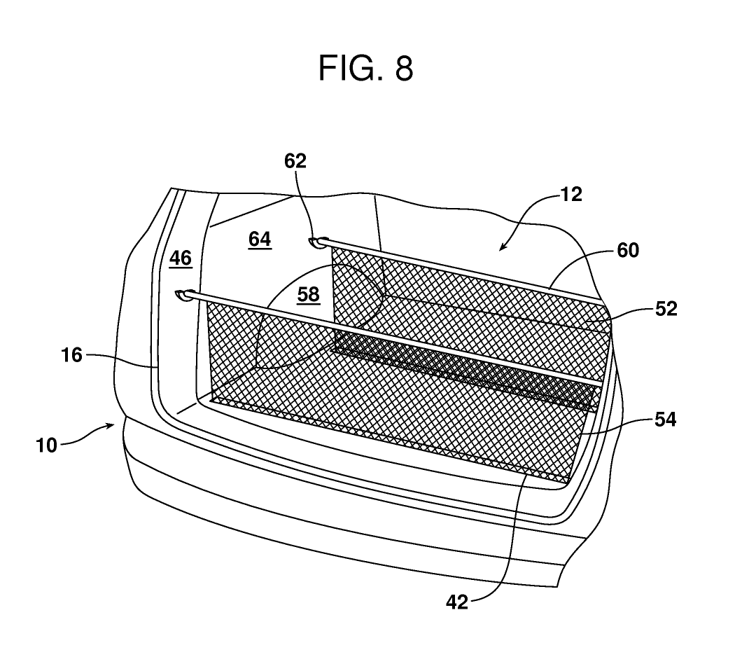

In alternate embodiments, more than one flexible member or cargo net 22 may be utilized to divide the rear cargo area 12 into multiple sections. In this manner, different types of cargo may be secured in sectional areas of the rear cargo area 14 as desired by the vehicle operator. In one such alternate embodiment show in FIGS. 7 and 8, a second or intermediate cargo net 52 is positioned a distance (d) inward from a first cargo net 54 which is adjacent to and extends across a width of the vehicle 10 sufficient to cover the width of the rear lift gate opening frame 16. The first cargo net 54 can be the same as the above-described embodiment wherein only one cargo net is utilized.

The second cargo net 52 is the same as the first cargo net 54 in all aspects except for the location of a recess 56, possibly shorter in width due to wheel wells 58, wherein the cargo net resides in the stowed position. As shown in FIG. 8, the cover 60 is secured by receivers 62 or the like positioned on sides 64 or pillars within the vehicle rear cargo area 12 in an extended (or installed) position. In this extended position, the second cargo net 52 is fully functional to prevent cargo from moving forward within the cargo area 12 and together with the first cargo net 54 operate to maintain cargo in an area defined by the first and second cargo nets 52, 54 and the side walls 64, 66 within the rear cargo area. As with the first cargo net 22, torsion springs associated with the second cargo net are energized by movement to the extended position and facilitate quick and easy uninstallation and return to the stowed position.

In summary, numerous benefits result from the utilization of retractable cargo nets within the rear cargo area of a vehicle as illustrated in this document. The cargo net(s) is quickly and easily moved from an out of sight stowed position to an installed position to prevent cargo from falling out of the cargo area as soon as the lift gate or deck lid is opened, or from moving around within the rear cargo area when multiple cargo nets are utilized. Even more, the cargo net is quickly and easily uninstalled and returned to the stowed position to avoid creating an obstruction to loading cargo and/or simply be in the way when not in use. Even more, the cargo net is stowed beneath a cover and out of sight in a manner that does not detract from the aesthetic appearance of the cargo area.

The foregoing has been presented for purposes of illustration and description. It is not intended to be exhaustive or to limit the embodiments to the precise form disclosed. Obvious modifications and variations are possible in light of the above teachings. For instance, a plurality of cargo nets could be utilized to subdivide the rear cargo area into any number of separate areas. All such modifications and variations are within the scope of the appended claims when interpreted in accordance with the breadth to which they are fairly, legally and equitably entitled.

1. A vehicle having a cargo area partially defined by a floor and a lift gate opening frame, comprising:
a support bar anchored to the floor along a width of the lift gate opening frame for rotational movement adjacent said lift gate opening frame;
a flexible material attached to said support bar at a first end, said flexible material rolled around said support bar in a stowed position and unrolled from said support bar in an extended position; and
a cover attached to said flexible material at a second end, said cover concealing said support bar and said flexible material in the stowed position and maintaining said flexible material in the extended position.

2. The vehicle of claim 1, further comprising at least one spring associated with said support bar, said at least one spring is in an unenergized state in the stowed position and an energized state in the extended position.

3. The vehicle of claim 2, wherein said at least one spring is a coil type spring.

4. The vehicle of claim 3, wherein said support bar includes at least one outboard compartment for housing said at least one spring.

5. The vehicle of claim 1, wherein said support bar and said flexible material are positioned within a recess formed in said floor in the stowed position.

6. The vehicle of claim 5, further comprising first and second pins extending from ends of said support bar;
first and second grommets attached to a wall of said recess for receiving said first and second pins; and
first and second brackets attached to said first and second grommets and securing said first and second pins within said first and second grommets for rotational movement of said support bar.

7. The vehicle of claim 5, wherein said cover is substantially flush with said floor in the stowed position.

8. The vehicle of claim 7, wherein said cover includes a tab for grasping when moving said flexible material from the stowed position to the extended position.

9. The vehicle of claim 7, wherein said cover includes an aperture for inserting a tool therein when moving said flexible material from the stowed position to the extended position.

10. A vehicle having a cargo area partially defined by a floor and a lift gate opening frame, comprising:
a support anchored for rotational movement substantially within a recess beneath the floor and adjacent the lift gate opening frame;
a retractable flexible member attached to said support at a first end, said retractable flexible member rolled around said support in a stowed position and unrolled from said support in an extended position; and
a cover attached to said retractable flexible member at a second end,
wherein said cover is substantially flush with said floor and conceals said support and said retractable flexible member in the stowed position.

11. The vehicle of claim 10, further comprising first and second springs attached to said support bar such that said first and second springs are in an unenergized state in the stowed position and an energized state in the extended position.

12. The vehicle of claim 11, wherein said support includes first and second outboard areas for receiving said first and second springs.

13. The vehicle of claim 10, wherein said cover is secured, in the extended position, to an interior structure of said vehicle.

14. The vehicle of claim 10, further comprising a carpet covering said floor, wherein a color of said cover substantially matches a color of said carpet.

15. The vehicle of claim 10, further comprising at least one additional support anchored for rotational movement substantially within a recess beneath said floor within said cargo area;
at least one additional retractable flexible member attached to said at least one additional support at a first end, said at least one additional retractable flexible member rolled around said at least one additional support in a stowed position and unrolled from said support in an extended position; and
at least one additional cover attached to said at least one additional retractable flexible member at a second end,
wherein said at least one additional cover is substantially flush with said floor and conceals said at least one additional support and said at least one additional retractable flexible member in the stowed position.

16. A vehicle having a cargo area partially defined by a floor and a lift gate opening frame, comprising:
a retractable net anchored at a first end within a recess in said floor, said retractable net rolled around a support and positioned within said recess in a stowed position and secured at a second end to an interior structure of said vehicle in an extended position; and
a cover, said cover substantially flush with said floor and concealing said retractable net in the stowed position.

17. The vehicle of claim 16, wherein said support is anchored for rotational movement within said recess and said retractable net is attached to said support at the first end.

18. The vehicle of claim 17, further comprising a pair of springs positioned along opposing ends of said support and acting upon said support, said pair of springs being in an unenergized state in the stowed position and an energized state in the extended position.

19. The vehicle of claim 17, wherein said retractable net is attached to a handle at a second end to assist in initiating movement of the cover.

20. The vehicle of claim 16, wherein said retractable net is attached to said cover at a second end and, in the extended position, said cover is secured by said interior structure of said vehicle.
